(19) United States
(12) Patent Application Publication
(10) Pub. No.: US 2022/0147869 A1
(43) Pub. Date: May 12, 2022

(54) TRAINING TRAINABLE MODULES USING LEARNING DATA, THE LABELS OF WHICH ARE SUBJECT TO NOISE

(71) Applicant: Robert Bosch GmbH, Stuttgart (DE)

(72) Inventors: Jan Mathias Koehler, Stuttgart (DE); Maximilian Autenrieth, Eislingen/Fils (DE); William Harris Beluch, Stuttgart (DE)

(21) Appl. No.: 17/420,357

(22) PCT Filed: Apr. 8, 2020
(86) PCT No.: PCT/EP2020/060004

§ 371 Date: Jul. 1, 2021

(30) Foreign Application Priority Data
Apr. 26, 2019 (DE) 10 2019 206 047.1

(51) Int. Cl. G06N 20/00; G06N 7/00

(52) U.S. Cl. CPC G06N 20/00; G06N 7/005

(57) ABSTRACT

A method for training a trainable module. A plurality of modifications of the trainable module, which differ from one another enough that they are not congruently merged into one another with progressive learning, are each pretrained using a subset of the learning data sets. Learning input variable values of a learning data set are supplied to all modifications as input variables; from the deviation of the output variable values, into which the modifications each convert the learning input variable values, from one another, a measure of the uncertainty of these output variable values is ascertained and associated with the learning data set as its uncertainty. Based on the uncertainty, an assessment of the learning data set is ascertained, which is a measure of the extent to which the association of the learning output variable values with the learning input variable values in the learning data set is accurate.

### FIELD

The present invention relates to the training of trainable modules, as are used, for example, for classification tasks and/or object recognition in at least semi-automated driving.

### BACKGROUND INFORMATION

Driving a vehicle in road traffic by a human driver is generally trained in that a student driver is confronted again and again with a defined canon of situations within the scope of his instructions. The student driver has to react to each of these situations and receives feedback as to whether his reaction was right or wrong by commentary or even intervention of the driving instructor. This training using a finite number of situations is to make the student driver capable of also mastering unknown situations when independently driving the vehicle.

To permit vehicles to participate in road traffic in a completely or semi-automated manner, efforts are made to control them using modules trainable in a very similar way. These modules receive, for example, sensor data from the vehicle surroundings as input variables and supply as output variables activation signals, which are used to intervene in the operation of the vehicle, and/or preliminary products, from which activation signals are formed. For example, a classification of objects in the surroundings of the vehicle may be such a preliminary product.

For this training, a sufficient quantity of learning data sets is required, which each include learning input variable values and associated learning output variable values. For example, the learning input variable values may include images and may be labeled, using the information as to which objects are contained in the images, as learning output variable values.

### SUMMARY

A method for training a trainable module is provided within the scope of the present invention. The trainable module converts one or multiple input variables into one or multiple output variables.

A trainable module is understood in particular as a module which involves a function parameterized using adaptable parameters having a great power for generalization. The parameters may in particular be adapted during the training of a trainable module in such a way that upon input of learning input variable values into the module, the associated learning output variable values are reproduced as well as possible. The trainable module may include in particular an artificial neural network (ANN), and/or it may be an ANN.

In accordance with an example embodiment of the present invention, the training takes place on the basis of learning data sets which contain learning input variable values and associated learning output variable values. At least the learning input variable values include measured data which were obtained by a physical measuring process, and/or by a partial or complete simulation of such a measuring process, and/or by a partial or complete simulation of a technical system observable using such a measuring process.

The term “learning data set” does not refer to the entirety of all available learning data, but rather a combination of one or multiple learning input variable values and learning output variable values associated with precisely these learning input variable values as the label. In a trainable module used for the classification and/or regression, a learning data set may include, for example, an image as a matrix of learning input variable values, in combination with the softmax scores which the trainable module is ideally to generate therefrom, as a vector of learning output variable values.

In accordance with an example embodiment of the present invention, within the scope of the method, a plurality of modifications of the trainable module are each pretrained at least using a subset of the learning data sets. The modifications differ from one another enough that they are not merged congruently into one another during progressive learning. The modifications may be structurally different, for example. For example, multiple modifications of ANNs may be generated in that different neurons are deactivated in each case within the scope of a “dropout.” However, the modifications may also be generated, for example, by pretraining using sufficiently different subsets of all the existing learning data sets, and/or by pretraining starting from sufficiently different initializations.

The modifications may be pretrained independently of one another, for example. However, it is also possible to bundle the pretraining in that only one trainable module or one modification is trained and further modifications are generated from this module or this modification only after completion of this training.

After the pretraining, learning input variable values of at least one learning data set are supplied to all modifications as input variables. These identical learning input variable values are converted by the various modifications into different output variable values. A measure of the uncertainty of these output variable values is ascertained from the deviation of these output variable values from one another and associated with the learning data set as a measure for its uncertainty.

The output variable values may be softmax scores, for example, which indicate with which probabilities the learning data set is classified in which of the possible classes.

In accordance with an example embodiment of the present invention, an arbitrary statistical function may be used for ascertaining the uncertainty from a plurality of output variable values. Examples of such statistical functions are the variance, the standard deviation, the mean value, the median, a suitably selected quantile, the entropy, and the variation ratio.

If the modifications of the trainable module have been generated in various ways, for example, on the one hand by “dropouts” and, on the other hand, by other structural changes or by a different initialization of the pretraining, in particular, for example, the deviations between those output variable values which are supplied by modifications generated in various ways may be compared separately from one another. Thus, for example, the deviations between output variable values which were supplied by modifications resulting due to “dropouts” and the deviations between output variable values which were supplied by modifications structurally changed in another way may be considered separately from one another.

The term of the “deviations” and the “uncertainty” is not restricted in this context to a one-dimensional, univariate case, but rather includes variables of arbitrary dimension. Thus, for example, multiple uncertainty features may be combined to obtain a multivariate uncertainty. This increases the differentiation accuracy between learning data sets having an accurate association of the learning output variable values with the learning input variable values (i.e., “accurately labeled” learning data sets), on the one hand, and learning data sets having an inaccurate association (i.e., “inaccurately labeled” learning data sets), on the other hand.

An assessment of the learning data set is ascertained on the basis of the uncertainty, which is a measure of the extent to which the association of the learning output variable values with the learning input variable values is accurate in the learning data set.

It has been found that in the event of an accurate association of the learning output variable values with the learning input variable values, the different modifications of the trainable module have a tendency to output corresponding “opinions” with respect to the output variable. The piece of information concealed in the accurate association so to speak prevails during the pretraining and has an effect in that the differences between the modifications manifest themselves a little or not at all in different output variables. The less accurate the association is, the more precisely this effect is absent and the greater the deviations are between the output variable values which the modifications each supply for the identical learning input variable values.

If all learning data sets are analyzed in this way, it will typically prove that the association is accurate to a greater extent for some learning data sets than for other learning data sets. This primarily reflects the fact that the association, thus the labeling, is carried out by humans in most applications of trainable modules and is accordingly susceptible to error. For example, only a very short time may be available to the human in the interest of a high throughput per learning data set, so that in cases of doubt he may not research more accurately, but rather has to make some decision. Different processors may also interpret the criteria according to which they are to label differently, for example. For example, if an object casts a shadow in an image, one processor may count this shadow with the object, since it was caused by the presence of the object. In contrast, another processor may not count the shadow with the object, with the reasoning that the shadow is not something with which a human or a vehicle may collide.

The ultimate useful application of the ascertained assessment is to be able to take selective measures to improve the ultimate training of the trainable module. The finished trained module may then perform, for example, a classification and/or regression of measured data, which are presented to it as input variables, with a higher accuracy. Therefore, in the respective technical application, for example in the case of at least semi-automated driving, a decision suitable for the particular situation is made with higher probability on the basis of given measured data.

In one particularly advantageous embodiment of the present invention, adaptable parameters which characterize the behavior of the trainable module are optimized with the goal of improving the value of a cost function. In an ANN, these parameters include, for example, the weights with which the inputs supplied to one neuron are offset for an activation of this neuron. The cost function measures to what extent the trainable module maps the learning input variable values contained in learning data sets on the associated learning output variable values. In conventional training of trainable modules, all learning data sets are equal in this aspect, i.e., the cost function measures how well the learning output variable values are reproduced on average. In this process, the ascertained assessment is introduced in such a way that the weighting of at least one learning data set in the cost function is dependent on its assessment.

For example, a learning data set may be weighted less the worse its assessment is. This may go up to the point that in response to the assessment of a learning data set meeting a predefined criterion, this learning data set drops out of the cost function entirely, i.e., is no longer used at all for the further training of the trainable module. The finding underlies this that the additional benefit provided by the consideration of a further learning data set may be entirely or partially compensated, or even overcompensated, by the contradictions resulting in the training process from an inaccurate or incorrect learning output variable value. No information may thus be better than spurious information.

In a further particularly advantageous embodiment of the present invention, in response to the assessment of a learning data set meeting a predefined criterion, an update of at least one learning output variable contained in this learning data set may be requested. The criterion may be, for example, that the assessment of the learning data set remains below a predefined minimum standard and/or is particularly poor in comparison to the other learning data sets. The requested update may be incorporated by a human expert or retrieved via a network, for example. The finding underlies this that many errors occurring during labeling are individual errors, for example, oversights. The necessity for an update may also result, for example, in a situation in which there are simply not enough examples in the learning data sets for the training of a reliable recognition of specific objects. For example, certain traffic signs, such as sign 129 “waterfront” occur comparatively rarely and may be underrepresented on images recorded during test journeys. The requested update as it were gives the trainable module tutoring in precisely this point.

In one particularly advantageous embodiment of the present invention, a distribution of the uncertainties is ascertained on the basis of a plurality of learning data sets. The assessment of a specific learning data set is ascertained on the basis of this distribution. The information from the plurality of learning data sets is aggregated in the distribution, so that a decision may be made with better accuracy about the assessment of a specific learning data set.

In one particularly advantageous embodiment of the present invention, the distribution is modeled as a superposition of multiple parameterized contributions, which each originate from learning data sets having identical or similar assessment. The parameters of these contributions are optimized in such a way that the deviation of the observed distribution of the uncertainties from the superposition is minimized. The contributions are ascertained in this way.

There is freedom here as to what type the superposition is. The superposition may be additive, for example. The superposition may also be, for example, that for each value of the uncertainty, the particular highest value of the various contributions is selected.

For example, the distribution may be modeled as a superposition of a contribution which originates from accurately labeled learning data sets (“clean labels”) and a contribution which originates from inaccurately labeled learning data sets (“noisy labels”). However, for example, a further contribution for learning data sets may also be introduced, the labels of which are moderately reliable.

In particular, a piece of additional information as to which function rule characterizes the distribution of the individual contributions in each case may be taken into consideration by the modeling. After the parameters of the contributions are determined and the contributions are thus established as a whole, the contributions may be used, for example, to assess specific learning data sets. In one particularly advantageous embodiment, the assessment of at least one learning data set is ascertained on the basis of a local probability density, which outputs at least one contribution to the superposition when the uncertainty of this learning data set is supplied to it as an input, and/or on the basis of a ratio of such local probability densities. For example, the distribution may be modeled by a superposition of a first contribution, which represents accurately labeled (“clean”) learning data sets, and a second contribution, which represents inaccurately labeled (“noisy”) learning data sets. The first contribution then supplies, upon input of uncertainty u, a probability p_{c}(u) that it is an accurately labeled learning data set. The second contribution supplies, upon input of uncertainty u, a probability pₙ(u) that it is an inaccurately labeled learning data set.

Furthermore, a chance (odds ratio) r may be determined that a learning data set is labeled inaccurately in comparison to accurately. This odds ratio r may be ascertained, for example, according to the rule

r=(pₙ(u)/(1−pₙ(u))/(p_{c}(u)/(1−p_{c}(u)).

It may be decided from odds ratio r or also from the ratio of pₙ(u) to p_{c}(u) upon exceeding a specific value, for example, that the learning data set is an inaccurately labeled (“noisy”) learning data set.

Alternatively, or also in combination therewith, it may also be incorporated in the assessment of at least one learning data set which contribution the learning data set is associated with in the optimization of the parameters of the contributions. Certain algorithms for optimizing the parameters, such as the expectation maximization algorithm, directly return which learning data sets were used for fitting the contributions to the distribution. In the above-explained example, the portion of the learning data sets which were used for fitting the second contribution, representing the inaccurately labeled learning data sets, to the distribution may be assessed, for example, as an estimation of the portion of the inaccurately labeled learning data sets.

It may also be observed, for example, during the pretraining, for example in every nth epoch, whether a learning data set was used for fitting the first contribution representing the accurately labeled learning data sets or for fitting the second contribution representing the inaccurately labeled learning data sets. This association may change from epoch to epoch. At the end of the pretraining, the learning data set may be classified as inaccurately labeled, for example, if it was classified as inaccurately labeled in the predominant number of the studied epochs.

However, further pieces of information may be read on the contributions, which characterize the entirety of the learning data sets analyzed in the distribution. In one particularly advantageous embodiment, it is thus at least ascertained on the basis of the deviation of the distribution from the superposition whether essentially only learning data sets having identical or similar assessments have contributed to the distribution. For example, it may be tested in this way whether essentially only accurately labeled learning data sets are present or whether there are still inaccurately labeled learning data sets, with respect to which one or multiple of the described selective measures may still be taken. That means, this test may be used, for example, as an abort criterion for such selective measures.

If an approach using two parameterized contributions is made for the superposition, for example, it is then more or less enforced that the superposition contains two contributions as a function of the specific algorithm used for the optimization of the parameters. However, if two contributions are actually not present in the distribution, for example, because essentially all learning data sets are accurately labeled, the deviation between the superposition and the distribution is then comparatively large even after the completion of the optimization. The actual distribution of the uncertainties is centered around a comparatively low value, while the superposition seeks a second such center. It is then no longer reasonable to “relabel” further learning data sets by updating the learning output variable values or to underweight them in the cost function for the training of the trainable module.

In accordance with an example embodiment of the present invention, it may be ascertained, for example using statistical tests, whether essentially only learning data sets having identical or similar assessments have contributed to the distribution. Such tests check whether the underlying data follow a spot check of a predefined distribution or whether the ascertained superposition is in accordance with the learning data sets. Examples of this are the Shapiro-Wilk test (for the normal distribution) and the Kolmogorov-Smirnov test. Alternatively, or also in combination therewith, for example, the visual plots of the deviation between the distribution and the superposition, for example a Q-Q plot, may be converted into metric variables. In the Q-Q plot, for example, the mean deviation from the diagonal may be used for this purpose.

In a further particularly advantageous embodiment of the present invention, various contributions to the superposition are modeled using identical parameterized functions, but parameters independent of one another. None of the contributions is then distinguished in relation to another, so that it solely acts according to the ultimately resulting statistics across all learning data sets, which learning data set is associated with which contribution.

Examples of parameterized functions, using which the contributions may each be modeled, are statistical distributions, in particular distributions from the exponential family, such as in particular the normal distribution, the exponential distribution, the gamma distribution, the chi-square distribution, the beta distribution, the exponential Weibull distribution, and the Dirichlet distribution. It is particularly advantageous if the functions have the interval [0, 1] or (0, 1) as the carrier (nonzero set), since some options for the calculation of the uncertainty, such as a mean value over softmax scores, supply values in the interval (0, 1). The beta distribution is an example of a function having such a carrier.

The parameters of the contributions may be optimized, for example, according to a likelihood method and/or according to a Bayesian method, in particular using the expectation maximization algorithm, using the expectation/conditional maximization algorithm, using the expectation conjugate gradient algorithm, using the Riemann batch algorithm, using a Newton-based method (such as Newton-Ralphson), using a Markov chain Monte Carlo-based method (such as Gibbs sampler or Metropolis-hasting algorithm), and/or using a stochastic gradient algorithm. The expectation maximization algorithm is particularly suitable for this purpose. As explained above, this algorithm directly supplies a piece of information as to which learning data sets were used for fitting which contribution to the distribution. The Riemann batch algorithm is described in greater detail in arXiv:1706.03267.

In another particularly advantageous embodiment of the present invention, the Kullback-Liebler divergence, the Hellinger distance, the Lévy distance, the Lévy-Prochorov metric, the Wasserstein metric, the Jensen-Shannon divergence, and/or another scalar measure for the extent to which these contributions differ from one another is ascertained from the modeled contributions. In this way, it may be judged how sharply the various contributions are at all separated from one another.

Furthermore, the scalar measure may be used to optimize the duration of the pretraining of the modifications. Therefore, in a further particularly advantageous embodiment, a dependence of the scalar measure on a number of epochs, and/or on a number of training steps, of the pretraining of the modifications is ascertained.

One tendency may be, for example, that an allocation of the distribution of the uncertainties in multiple contributions does form initially within the scope of the pretraining, but is partially leveled out again during the further progress of the pretraining. As explained above, inaccurately labeled learning data sets result in contradictions in the pretraining. The pretraining may attempt to resolve these contradictions using a “compromise.” The difference between accurately labeled and inaccurately labeled learning data sets is clearest at a point in time at which this process has not yet begun.

Therefore, in another particularly advantageous embodiment of the present invention, a number of epochs, and/or a number of training steps, in which the scalar measure indicates a maximum differentiation of the contributions to the superposition, is used for the further ascertainment of uncertainties of learning data sets.

The present invention also relates to a further method which continues the action chain of the training with the operation of the trainable module trained thereby. In accordance with an example embodiment of the present invention, in this method, first a trainable module which converts one or multiple input variables into one or multiple output variables is trained using the above-described method. Subsequently, the trainable module is operated in that input variable values are supplied to it.

These input variable values include measured data which were obtained by a physical measuring process, and/or by a partial or complete simulation of such a measuring process, and/or by a partial or complete simulation of a technical system observable using such a measuring process.

The trainable module converts the input variable values into output variable values. A vehicle, and/or a classification system, and/or a system for quality control of products manufactured in series, and/or a system for medical imaging is activated using an activation signal as a function of these output variable values.

For example, the trainable module may supply a semantic segmentation of images from the surroundings of the vehicle. This semantic segmentation classifies the image pixels according to the types of objects to which they belong. On the basis of this semantic segmentation, the vehicle may then be activated so that it only moves within freely negotiable areas and avoids collisions with other objects, such as structural roadway boundaries or other road users.

For example, within the scope of a quality control, the trainable module may classify exemplars of a specific product on the basis of physical measured data into two or more quality classes. A specific exemplar may be marked as a function of the quality class, for example, or a sorting device may be activated in such a way that it is separated from other exemplars having other quality classes.

For example, within the scope of medical imaging, the trainable module may classify whether or not a recorded image indicates a specific clinical picture and which degree of severity of the illness possibly exists. For example, the physical process of the image recording may be adapted as a function of the result of this classification in such a way that a still more clear differentiation as to whether the corresponding clinical picture exists is enabled on the basis of further recorded images. Thus, for example, the focus or the illumination of a camera-based system for imaging may be adapted.

In particular, in the field of medical imaging, labeling, thus the association of accurate learning output variable values with given learning input variable values, is particularly susceptible to error, because it is often based on the empirical knowledge of human experts in the judgment of images. This empirical knowledge is only to be grasped with difficulty, if at all, in quantitative criteria for the judgment of the images.

The present invention also relates to a parameter set having parameters which characterize the behavior of a trainable module and which were obtained using the above-described method. These parameters may be, for example, weights, using which inputs of neurons or other processing units in an ANN are offset with activations of these neurons or processing units. This parameter set involves the expenditure which was invested in the training and is thus an independent product.

The method may in particular be implemented entirely or partially in software. The present invention therefore also relates to a computer program including machine-readable instructions which, when they are executed on one or multiple computers, prompt the computer or computers to carry out one of the described methods.

The present invention also relates to a machine-readable data medium and/or to a download product including the computer program. A download product is a digital product transferable via a data network, i.e., downloadable by a user of the data network, which may be offered for sale in an online shop for immediate download, for example.

Furthermore, a computer may be equipped with the computer program, the machine-readable data medium, or the download product.

Further measures which improve the present invention are explained in greater detail hereinafter together with the description of the preferred exemplary embodiments of the present invention on the basis of figures.

### BRIEF DESCRIPTION OF THE DRAWINGS

FIG. 1 shows an exemplary embodiment of method 100 for training, in accordance with the present invention.

FIG. 2 shows an exemplary embodiment of method 200 including complete action chain up to the activation of a technical system, in accordance with the present invention.

FIG. 3 shows exemplary modeling of a distribution 3 of uncertainties 2a by a superposition 4 made up of two contributions 41, 42, in accordance with the present invention.

FIG. 4 shows failure of the modeling in the case that essentially all learning data sets 2 are accurately labeled.

### DETAILED DESCRIPTION OF EXAMPLE EMBODIMENTS

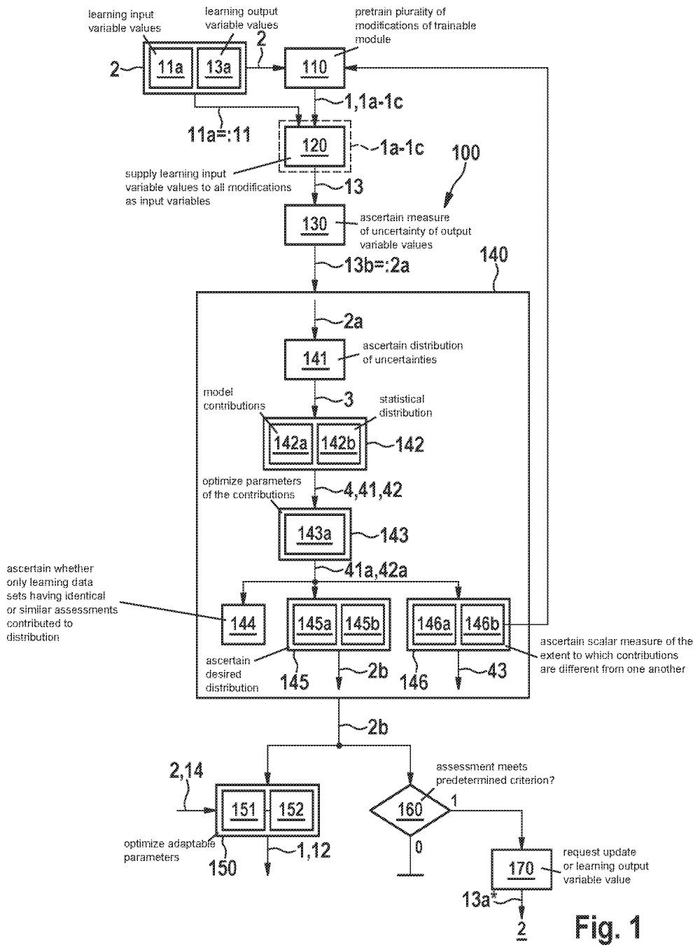

FIG. 1 shows an exemplary embodiment of method 100 for training a trainable module 1. In step 110, a plurality of modifications 1a-1c of trainable module 1 are pretrained at least using a subset of existing learning data sets 2. Each learning data set 2 contains learning input variable values 11a and associated learning output variable values 13a.

In step 120, learning input variable values 11a from learning data sets 2 are supplied to all modifications 1a-1c as input variables 11. Each modification 1a-1c generates a separate output variable value 13 therefrom. In step 130, a measure of the uncertainty 13b of these output variable values is ascertained from the deviations of these output variable values 13 from one another. This measure of uncertainty 13b is associated with learning data set 2, from which learning input variable values 11a were taken, as a measure of its uncertainty 2a.

An assessment 2b of learning data set 2 is ascertained from this uncertainty 2a in step 140. This assessment 2b is a measure of the extent to which the association of learning output variable values 13a with learning input variable values 11a, thus the labeling of learning data set 2, is accurate in learning data set 2. It is broken down within box 140, for example, how assessment 2b may be ascertained.

For example, according to block 141, on the basis of a plurality of learning data sets 2, a distribution 3 of uncertainties 2a may be ascertained and this distribution 3 may subsequently be further evaluated.

Distribution 3 may be modeled, for example, according to block 142, as a superposition of multiple parameterized contributions 41, 42. For this purpose, according to block 142a, for example, various contributions 41, 42 may be modeled using identical parameterized functions however using parameters 41a, 42a independent of one another. According to block 142b, for example, statistical distributions may be used, in particular distributions from the exponential family, such as in particular a normal distribution, an exponential distribution, a gamma distribution, a chi-square distribution, a beta distribution, an exponential Weibull distribution, and a Dirichlet distribution.

Parameters 41a, 42a of the contributions may be optimized according to block 143, for example, in such a way that the deviation of observed distribution 3 from ascertained superposition 4 is minimized. For this optimization, according to block 143a, for example, a likelihood method and/or a Bayesian method, such as an expectation maximization algorithm, an expectation/conditional maximization algorithm, an expectation conjugate gradient algorithm, a Riemann batch algorithm, a Newton-based method (such as Newton-Ralphson), a Markov chain Monte Carlo-based method (such as Gibbs sampler or Metropolis-Hasting algorithm), and/or a stochastic gradient algorithm may be used.

The deviation of distribution 3 from superposition 4 may, according to block 144, already supply the important information as to whether essentially only learning data sets 2 having identical or similar assessments 2b have contributed to distribution 3. For example, if accurately labeled learning data sets 2 are to be differentiated from inaccurately labeled learning data sets 2 using contributions 41 and 42 to superposition 4, the measures taken after the identification of inaccurately labeled data sets 2 may at some time have the result that there are essentially only accurately labeled learning data sets 2. This may be recognized according to block 144. An abort condition for said measures may be derived therefrom, for example.

In general, desired distribution 2b may be ascertained from distribution 3 according to block 145. According to block 145a, contributions 41, 42 to superposition 4, using which distribution 3 is modeled, may be used for this purpose. For example, such a contribution 41, 42 may associate an uncertainty 2a of a learning data set 2 with a local probability density, using which this learning data set 2 is labeled accurate or inaccurate. A corresponding odds ratio may be formed from multiple such local probability densities. Alternatively, or also in combination therewith, it may be observed, according to block 145b, which contribution 41, 42 a learning data set 2 is associated with upon optimizing 143 of parameters 41a, 42a of contributions 41, 42. As explained above, some algorithms for optimization directly supply a piece of information about which learning data sets 2 they are each supported on.

According to block 146, a scalar measure 43 of the extent to which these contributions 41, 42 are different from one another may be ascertained from contributions 41, 42 established by parameters 41a, 42a. This scalar measure 43 may be, for example, the Kullback-Leibler divergence. In particular, according to block 146a, the dependence of this scalar measure 43 on a number of epochs, and/or on a number of training steps, of pretraining 110 of modifications 1a-1c may be ascertained. One possible practical application, according to block 146b, is to deliberately select the number of epochs and/or training steps used during pretraining 110 in such a way that scalar measure 43 becomes maximal and thus contributions 41, 42 may be differentiated from one another in the best possible manner.

Furthermore, exemplary practical applications of assessment 2b of learning data sets 2 ascertained in step 140 are indicated in FIG. 1.

In step 150, ultimately required trainable module 1 may be trained in that adaptable parameters 12 which characterize the behavior of this trainable module 1 are optimized, with the goal of improving the value of a cost function 14. Cost function 14 measures, according to block 151, to what extent trainable module 1 maps learning input variable values 11a contained in learning data sets on associated learning output variable values 13a. According to block 152, the weighting of at least one learning data set 2 in cost function 14 is a function of its assessment 2b.

In step 160, alternatively or also in combination therewith, it may be checked whether assessment 2b of a learning data set 2 meets a predetermined criterion. The criterion may be, for example, that assessment 2b exceeds or falls below a predefined threshold value and/or assessment 2b classifies learning data set 2 as inaccurately labeled. If this is the case (truth value 1), in step 170, an update 13a* of learning output variable value 13a contained in learning data set 2 may be requested.

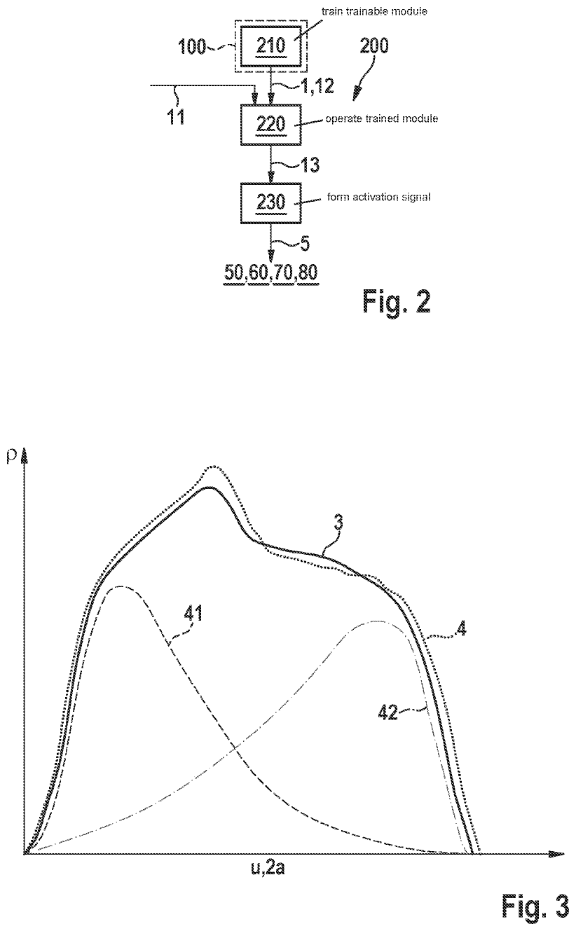

FIG. 2 shows an exemplary embodiment of method 200. In step 210 of this method 200, a trainable module 1 is trained using above-described method 100. The module trained in this way is operated in step 220, in that input variable values 11 including physically recorded and/or simulated measured data which relate to a technical system are supplied to it. In step 230, an activation signal 5 is formed from output variable values 13 thereupon supplied by trainable module 1. A vehicle 50, and/or a classification system 60, and/or a system 70 for quality control of products manufactured in series, and/or a system 80 for medical imaging is activated using this activation signal 5.

FIG. 3 shows by way of example how a distribution 3 of uncertainties 2a, u may be modeled by a superposition 4 made up of two contributions 41, 42. For each value of uncertainty 2a, u, in each case the value of a local probability density ρ, which results according to particular contribution 41, 42 as a function of particular uncertainty 2a, is plotted. Superposition 4 is formed in this example as the weighted addition of all uncertainties 2a and is shown decomposed into contributions 41, 42. However, for example, for each value of uncertainty 2a, u, in each case the higher function value of the two contributions 41, 42 may be selected. In the example shown in FIG. 3, first contribution 41, which is large in the case of lower uncertainties 2a, u, originates from accurately labeled learning data sets 2. Second contribution 42, which is large in the case of higher uncertainties 2a, u, originates from inaccurately labeled learning data sets 2.

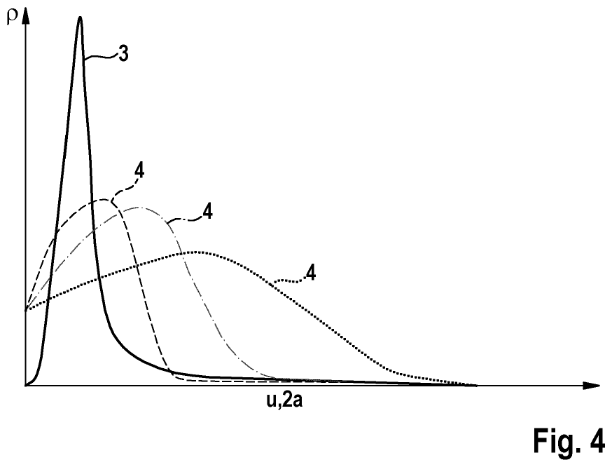

FIG. 4 shows by way of example how the model illustrated in FIG. 3 may fail if learning data sets 2 are all accurately labeled. Distribution 3 of uncertainties 2a, u is then centered around a low value. Each of the three models shown by way of example including superposition 4 still presume as before that there are two contributions 41, 42 and attempt to bring this approach into congruence somehow with distribution 3 according to the stipulation of an error degree (such as sum of least squares). As FIG. 4 shows, the deviation is large. A clear signal may be derived therefrom that all learning data sets 2 are accurately labeled.

1-20. (canceled)

21. A computer-implemented method for training a trainable module, which converts one or multiple input variables into one or multiple output variables, the training being with the aid of learning data sets which contain learning input variable values and associated learning output variable values, at least the learning input variable values including measured data, which were obtained by: (i) a physical measuring process, and/or (ii) a partial or complete simulation of the measuring process, and/or (iii) a partial or complete simulation of a technical system observable using the measuring process, the method comprising the following steps:
pretraining, at least using a subset of the learning data sets, each of a plurality of modifications of the trainable module, which differ from one another enough that the modifications are not congruently merged into one another with progressive learning;
supplying, as input variable, learning input variable values of at least one of the learning data sets to all of the modifications;
ascertaining, from a deviation from one another of output variable values, into which the modifications each convert the learning input variable values, a measure of the uncertainty of the output variable values, and associating with the at least one of the learning data sets as a measure of an uncertainty of the at least one of the learning data sets; and
based on the uncertainty, ascertaining an assessment of the at least one learning data set, which is a measure of an extent to which the association of the learning output variable values with the learning input variable values in the at least one learning data set is accurate;
wherein a distribution of the uncertainties is ascertained based on a plurality of the learning data sets and the assessment is ascertained based on the distribution, the distribution being modeled as a superposition of multiple parameterized contributions, which each originate from those of the learning data sets having identical or similar assessment, and parameters of the contributions being optimized in such a way that a deviation of the distribution from the ascertained superposition is minimized to ascertain the contributions.

22. The method as recited in claim 21, wherein adaptable parameters, which characterize a behavior of the trainable module, are optimized, with a goal of improving a value of a cost function, the cost function measuring an extent to which the trainable module maps the learning input variable values contained in the at least one learning data set on the associated learning output variable values, a weighting of the at least one learning data set in the cost function being a function of its assessment.

23. The method as recited in claim 22, wherein in response to the assessment of a learning data set of the at least one learning data set meeting a predefined criterion, the learning data set is no longer taken into consideration in the cost function.

24. The method as recited in claim 21, wherein in response to the assessment of a learning data set of the at least one learning data set meeting a predefined criterion, an update of at least one learning output variable value contained in the learning data set is requested.

25. The method as recited in claim 21, further comprising:
ascertaining based on the deviation of the distribution from the superposition whether only learning data sets having identical or similar assessments have contributed to the distribution.

26. The method as recited in claim 21, wherein various contributions to the superposition are modeled using identical parameterized functions, but using parameters independent from one another.

27. The method as recited in claim 21, wherein at least one of the parameterized contributions is modeled as a statistical distribution.

28. The method as recited in claim 27, wherein the statistical distribution is a normal distribution, and/or an exponential distribution, and/or a gamma distribution, and/or a chi-square distribution, and/or a beta distribution, and/or an exponential Weibull distribution, and/or a Dirichlet distribution.

29. The method as recited in claim 21, wherein the parameters of the contributions are optimized according to a likelihood method and/or according to a Bayesian method.

30. The method as recited in claim 21, wherein the parameters of the contributions are optimized using an expectation maximization algorithm, and/or using an expectation/conditional maximization algorithm, and/or using an expectation conjugate gradient algorithm, and/or using a Riemann batch algorithm, and/or using a Newton-based method, and/or using a Markov chain Monte Carlo-based method, and/or using a stochastic gradient algorithm.

31. The method as recited in claim 21, wherein the assessment of the at least one learning data set is ascertained based on a local probability density, which outputs at least one contribution to the superposition when the uncertainty of the at least one learning data set is supplied to it as an input, and/or based on a ratio of the local probability densities.

32. The method as recited in claim 21, wherein, in the assessment of the at least one learning data set, it is incorporated, to which contribution the at least one learning data set is associated during the optimizing of the parameters of the contributions.

33. The method as recited in claim 21, wherein a Kullback-Liebler divergence, and/or a Hellinger distance, and/or a Lévy distance, and/or a Lévy-Prochorov metric, and/or a Wasserstein metric, and/or a Jensen-Shannon divergence, and/or another scalar measure of an extent to which the contributions differ from one another is ascertained from the contributions.

34. The method as recited in claim 21, wherein a dependence of the scalar measure on a number of epochs, and/or on a number of training steps, of the pretraining of the modifications is ascertained, wherein the number of epochs, and/or the number of training steps, in which the scalar measure indicates a maximum differentiation of the contributions to the superposition, being used for a further ascertainment of uncertainties of learning data sets.

35. A computer-implemented method, comprising the following steps:
training a trainable module, the trainable module being configured to convert one or multiple input variables into one or multiple output variables, the training being with the aid of learning data sets which contain learning input variable values and associated learning output variable values, at least the learning input variable values including measured data, which were obtained by: (i) a physical measuring process, and/or (ii) a partial or complete simulation of the measuring process, and/or (iii) a partial or complete simulation of a technical system observable using the measuring process, the training including:
pretraining, at least using a subset of the learning data sets, each of a plurality of modifications of the trainable module, which differ from one another enough that the modifications are not congruently merged into one another with progressive learning,
supplying, as input variable, learning input variable values of at least one of the learning data sets to all of the modifications,
ascertaining, from a deviation from one another of output variable values, into which the modifications each convert the learning input variable values, a measure of the uncertainty of the output variable values, and associating with the at least one of the learning data sets as a measure of an uncertainty of the at least one of the learning data sets, and
based on the uncertainty, ascertaining an assessment of the at least one learning data set, which is a measure of an extent to which the association of the learning output variable values with the learning input variable values in the at least one learning data set is accurate,
wherein a distribution of the uncertainties is ascertained based on a plurality of the learning data sets and the assessment is ascertained based on the distribution, the distribution being modeled as a superposition of multiple parameterized contributions, which each originate from those of the learning data sets having identical or similar assessment, and parameters of the contributions being optimized in such a way that a deviation of the distribution from the ascertained superposition is minimized to ascertain the contributions
operating the trainable module by supplying to the trainable module first input variable values, the first input variable values including measured data, which were obtained by: (i) a physical measuring process, and/or (ii) a partial or complete simulation of the measuring process, and/or (iii) a partial or complete simulation of a technical system observable using the measuring process; and
as a function of output variable values supplied by the trainable module,
activating a vehicle and/or a classification system and/or a system for quality control of products manufactured in series, and/or a system for medical imaging, using an activation signal.

36. A non-transitory machine-readable data medium on which is stored a computer program for training a trainable module, which converts one or multiple input variables into one or multiple output variables, the training being with the aid of learning data sets which contain learning input variable values and associated learning output variable values, at least the learning input variable values including measured data, which were obtained by: (i) a physical measuring process, and/or (ii) a partial or complete simulation of the measuring process, and/or (iii) a partial or complete simulation of a technical system observable using the measuring process, the computer program, when executed by a computer, causing the computer to perform the following steps:
pretraining, at least using a subset of the learning data sets, each of a plurality of modifications of the trainable module, which differ from one another enough that the modifications are not congruently merged into one another with progressive learning;
supplying, as input variable, learning input variable values of at least one of the learning data sets to all of the modifications;
ascertaining, from a deviation from one another of output variable values, into which the modifications each convert the learning input variable values, a measure of the uncertainty of the output variable values, and associating with the at least one of the learning data sets as a measure of an uncertainty of the at least one of the learning data sets; and
based on the uncertainty, ascertaining an assessment of the at least one learning data set, which is a measure of an extent to which the association of the learning output variable values with the learning input variable values in the at least one learning data set is accurate;
wherein a distribution of the uncertainties is ascertained based on a plurality of the learning data sets and the assessment is ascertained based on the distribution, the distribution being modeled as a superposition of multiple parameterized contributions, which each originate from those of the learning data sets having identical or similar assessment, and parameters of the contributions being optimized in such a way that a deviation of the distribution from the ascertained superposition is minimized to ascertain the contributions.

37. A computer configured to train a trainable module, which converts one or multiple input variables into one or multiple output variables, the training being with the aid of learning data sets which contain learning input variable values and associated learning output variable values, at least the learning input variable values including measured data, which were obtained by: (i) a physical measuring process, and/or (ii) a partial or complete simulation of the measuring process, and/or (iii) a partial or complete simulation of a technical system observable using the measuring process, the computer being configured to:
pretrain, at least using a subset of the learning data sets, each of a plurality of modifications of the trainable module, which differ from one another enough that the modifications are not congruently merged into one another with progressive learning;
supply, as input variable, learning input variable values of at least one of the learning data sets to all of the modifications;
ascertain, from a deviation from one another of output variable values, into which the modifications each convert the learning input variable values, a measure of the uncertainty of the output variable values, and associating with the at least one of the learning data sets as a measure of an uncertainty of the at least one of the learning data sets; and
based on the uncertainty, ascertain an assessment of the at least one learning data set, which is a measure of an extent to which the association of the learning output variable values with the learning input variable values in the at least one learning data set is accurate;
wherein a distribution of the uncertainties is ascertained based on a plurality of the learning data sets and the assessment is ascertained based on the distribution, the distribution being modeled as a superposition of multiple parameterized contributions, which each originate from those of the learning data sets having identical or similar assessment, and parameters of the contributions being optimized in such a way that a deviation of the distribution from the ascertained superposition is minimized to ascertain the contributions.
